(19) United States
(12) Patent Application Publication
(10) Pub. No.: US 2025/0050475 A1
(43) Pub. Date: Feb. 13, 2025

(54) HAND TOOL

(71) Applicant: KABO TOOL COMPANY, Taichung City (TW)

(72) Inventor: Chih-Ching HSIEH, Taichung City (TW)

(21) Appl. No.: 18/798,793

(22) Filed: Aug. 8, 2024

(30) Foreign Application Priority Data
Aug. 10, 2023 (TW) 112130189

(51) Int. Cl. B25B 23/00; B25B 13/46

(52) U.S. Cl. CPC B25B 23/0028; B25B 13/46

(57) ABSTRACT

A hand tool includes a handle, a driving head and a stopping member. The driving head is pivotally connected to one end of the handle. The stopping member is disposed on the end of the handle. The handle includes a stepping structure located on the end of the handle. The driving head includes a positioning portion located on one end of the driving head facing towards the handle. The stopping member includes a stopping structure, wherein when the stopping member is pushed by the stepping structure towards the driving head, the stopping structure is positioned on the positioning portion so as to position the driving head and the handle with a preset angle.

### RELATED APPLICATIONS

This application claims priority to Taiwan Application Serial Number 112130189, filed Aug. 10, 2023, which is herein incorporated by reference.

### BACKGROUND

### Technical Field

The present disclosure relates to a hand tool. More particularly, the present disclosure relates to a hand tool which has the adjustable angle between a driving head and a handle thereof.

### Description of Related Art

Nowadays, various types of hand tools have been widely used in various industries and even in daily life. Compared with precision machines, general hand tools need convenience and low cost, so the hand tool industry continues to develop in this direction.

In order to adapt to different operating environments and application, many kinds of hand tools have developed variable structures, such as the hand tools with adjustable length or adjustable operating angle, to enhance the applicability of a single hand tool. However, hand tools with high applicability usually increase in weight due to complicated structures and multiple components, which is not conducive to operation and directly affects manufacturing costs. Therefore, how to simplify the components of hand tools while maintaining the required applicability and effectively reducing manufacturing costs is an urgent goal in the industry.

### SUMMARY

According to one aspect of the present disclosure, a hand tool includes a handle, a driving head and a stopping member. The driving head is pivotally connected to one end of the handle. The stopping member is disposed on the end of the handle. The handle includes a stepping structure located on the end of the handle. The driving head includes a positioning portion located on one end of the driving head facing towards the handle. The stopping member includes a stopping structure, wherein when the stopping member is pushed by the stepping structure towards the driving head, the stopping structure is positioned on the positioning portion so as to position the driving head and the handle with a preset angle.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional view of a hand tool according to one example of the present disclosure.

FIG. 2 is an exploded view of the hand tool according to the example of FIG. 1.

FIG. 3 is a schematic view of the driving head and the stopping member according to the example of FIG. 1.

FIG. 4A is a schematic view of the stopping structure and the positioning portion at one location in one status according to the example of FIG. 1.

FIG. 4B is a schematic view of the stopping structure and the positioning portion at another location in another status according to the example of FIG. 1.

FIG. 4C is a schematic view of the stopping structure and the positioning portion at further another location in further another status according to the example of FIG. 1.

FIG. 5 is a three-dimensional view of the hand tool under different status of the example of FIG. 1.

### DETAILED DESCRIPTION

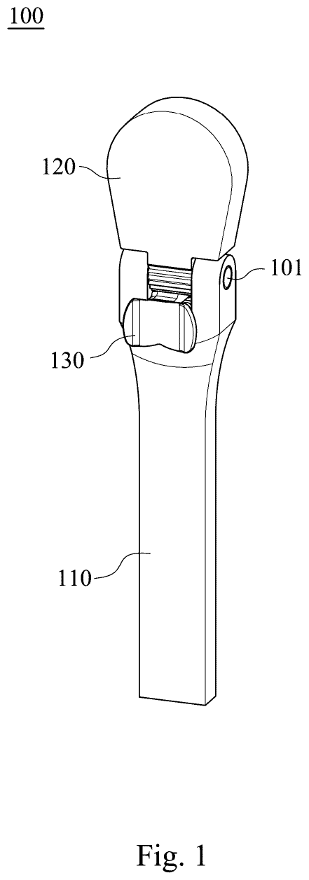

FIG. 1 is a three-dimensional view of a hand tool 100 according to one example of the present disclosure. In FIG. 1, the hand tool 100 includes a handle 110, a driving head 120 and a stopping member 130. The driving head 120 is pivotally connected to one end of the handle 110, and the stopping member 130 is disposed on the end of the handle 110. Specifically, the hand tool 100 is a swing wrench, the driving head 120 thereof can be pivoted relative to the handle 110, and the driving head 120 and the handle 110 with a preset angle can be positioned by the stopping member 130, that is, the preset angle between the driving head 120 and the handle 110 can be fixed. Therefore, it is favorable for properly adjusting the preset angle between the driving head 120 and the handle 110 so as to adapt different working pieces located on different locations, thus it is favorable for user to apply the force smoothly. It should be mentioned that the present disclosure is not limited to the swing wrench disclosed in the drawings and the examples, and can be applied to any hand tool with the requirement of angle adjustments between the driving head and the handle.

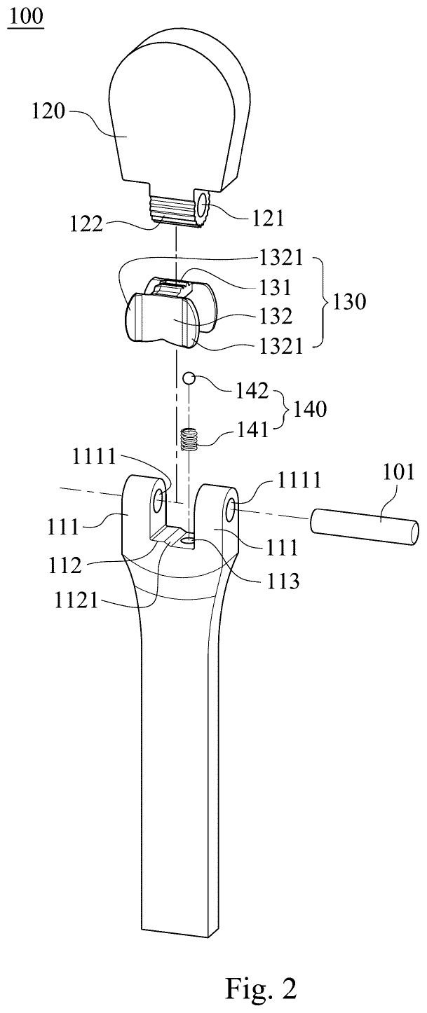

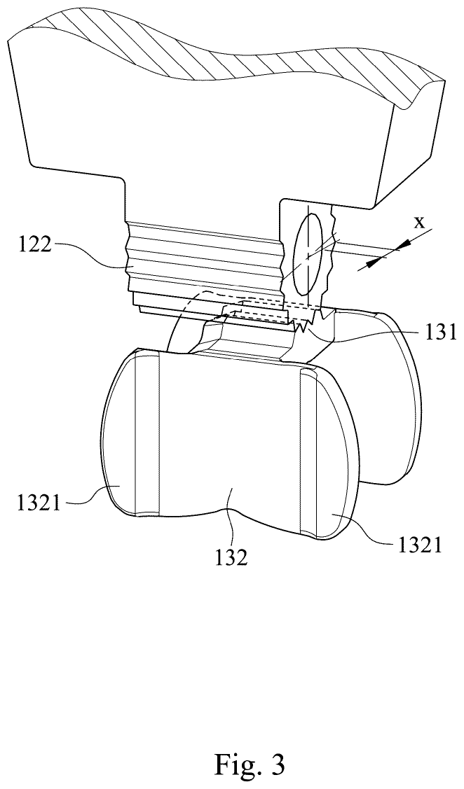

FIG. 2 is an exploded view of the hand tool 100 according to the example of FIG. 1. In FIG. 1 and FIG. 2, the handle 110 includes a stepping structure 112, which is located on the end (that is, the end pivotally connected to the driving head 120) of the handle 110, wherein the stepping structure 112 can be integrally formed with the handle 110, so that the pieces of the hand tool 100 can be simplified, but the present disclosure is not limited thereto. The driving head 120 includes a positioning portion 122, which is located on one end of the driving head 120 facing towards the handle 110. The stopping member 130 includes a stopping structure 131, which located on one side of the stopping member 130 facing towards the driving head 120. Please refer to FIG. 3, which is a schematic view of the driving head 120 and the stopping member 130 according to the example of FIG. 1. In FIG. 3, the stopping structure 131 of the stopping member 130 can be abutted against the positioning portion 122 of the driving head 120 so as to position the driving head 120 and the handle 110 with the preset angle.

In detail, the driving head 120 can further include a pivoting portion (its reference numeral is omitted), which is for pivotally connecting with the end of the handle 110. The end of the handle 110 can include two protruding flanges 111. The pivoting portion of the driving head 120 has a pivoting hole 121, each of the protruding flanges 111 has a pivoting hole 1111. There is a pivoting axial member 101 is passed through the pivoting hole 121 of the driving head 120 and the pivoting hole 1111 of each protruding flange 111, so that the driving head 120 and the handle 110 can be rotated relative to each other. Further, the positioning portion 122 of the driving head 120 includes a plurality of first teeth structures (its reference numeral is omitted), which is disposed around an outer surface of the pivoting portion. The stopping structure 131 of the stopping member 130 includes at least one second teeth structure (its reference numeral is omitted), which is for engaging with at least one of the first teeth structures. In FIG. 3, the stopping structure 131 includes a plurality of the second teeth structures (its reference numeral is omitted), but the present disclosure is not limited thereto. That is, when the first teeth structures and the second teeth structures are engaged with each other, the driving head 120 and the handle 110 cannot be rotated relative to each other and are fixed with the preset angle.

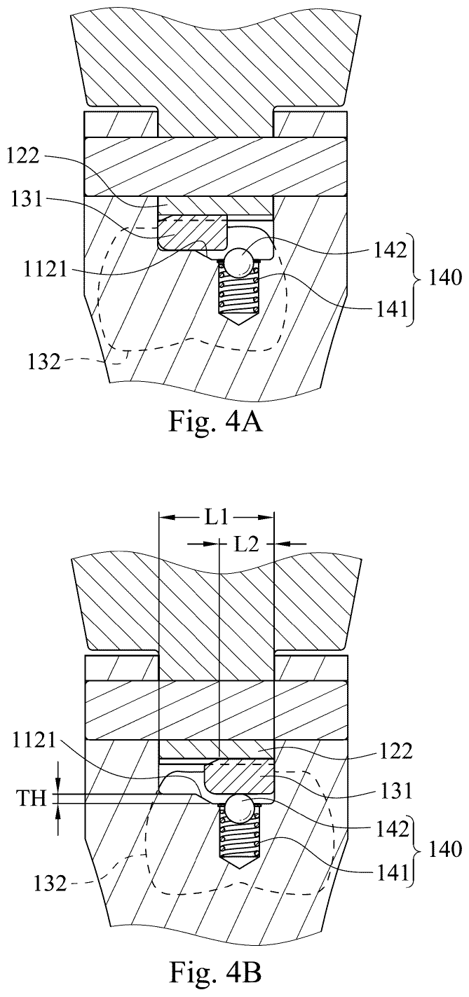

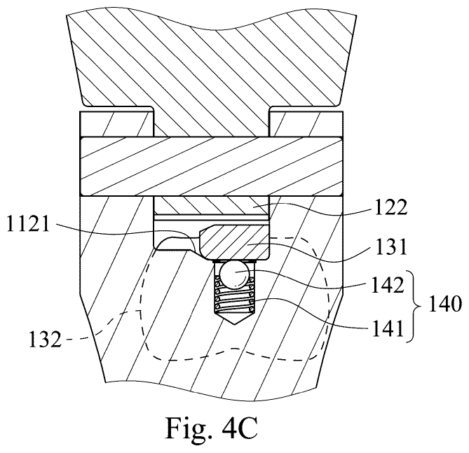

FIG. 4A, FIG. 4B and FIG. 4C are schematic views of the stopping structure 131 and the positioning portion 122 at different locations in different statuses according to the example of FIG. 1. In FIG. 2 and FIG. 4A, the stopping member 130 can be pushed by the positioning portion 122 of the handle 110, when the driving head 120 and the handle 110 are located with the preset angle, the stopping structure 131 is abutted against the positioning portion 122 of the driving head 120 and the first teeth structures and the second teeth structures can be engaged with each other, thus, the driving head 120 and the handle 110 can be positioned at the preset angle. Hence, it is favorable for operating the hand tool 100 under different environments.

Please refer to FIG. 2, FIG. 4B and FIG. 4C. The hand tool 100 can further include an assisting structure 140, wherein the handle 110 has a concave hole 113 located on the end of the handle 110 and being adjacent to the stepping structure 112. The assisting structure 140 is protrudably disposed in the concave hole 113. The assisting structure 140 can include an elastic member 141 and an abutting member 142. One end of the elastic member 141 is positioned in the concave hole 113, and the abutting member 142 is connected to the other end of the elastic member 141. As shown in FIG. 4A and FIG. 4B, when the elastic member 141 is not compressed, the abutting member 142 is about protruded from the concave hole 113. Specifically, in the present disclosure, the elastic member 141 is a spring, the abutting member 142 is a steel ball, but will not be limited thereto.

As shown in FIG. 4B, when the user would like to change or adjust the preset angle between the driving head 120 and the handle 110, first, the stopping member 130 can be moved along a direction parallel to an axial direction of the pivoting portion (that is, the axial direction of the pivoting axial member 101) towards the end of the stepping structure 112 which is far away from the positioning portion 122. At this time, the stopping member 130 is above the assisting structure 140, and contacted with the abutting member 142.

In FIG. 4C, when the user moves the stopping member 130 towards the direction away from the driving head 120 and pushes the abutting member 142, the positioning portion 122 can be released from the stopping structure 131, and the driving head 120 and the handle 110 can be rotated relative to each other. At this time, the user can change the preset angle between the driving head 120 and the handle 110 so as to adapt different applications in different locations or environments. Moreover, when the preset angle is adjusted to another expected angle, the stopping member 130 can be released and the elastic member 141 can provide the restoring force for pushing the stopping member 130 via the abutting member 142, thus, the first teeth structures and the second teeth structures can be engaged to each other (as the status shown in FIG. 4B). Then, the stopping member 130 can be moved back to the location relative to the stepping structure 112 (as the status shown in FIG. 4A), so that the hand tool 100 can be operated again stably. It should be mentioned, at the status shown in FIG. 4A, the stopping member 130 is not physically contacted with the assisting structure 140, but only contacted with the stepping structure 112, that is, the stopping member 130 can be stably and firmly positioned by the stepping structure 112 during the hand tool 100 is operated, and the structure of the hand tool 100 can be simplified.

Moreover, the stepping structure 112 can include a tilting surface 1121 located on an edge of the stepping structure 112 facing towards the assisting structure 140. Thus, the stopping member 130 can be pushed back from the status as shown in FIG. 4C to the status as shown in FIG. 4A along the tilting surface 1121, which is favorable for increasing the operating smoothness.

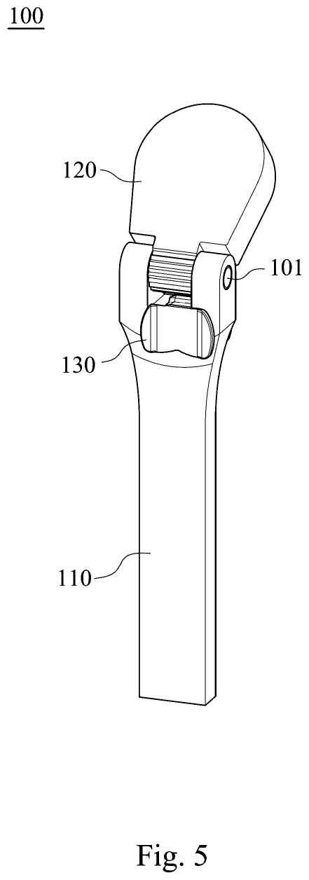

FIG. 5 is a three-dimensional view of the hand tool 100 under different status of the example of FIG. 1. In FIG. 5, the preset angel between the driving head 120 and the handle 110 is different from FIG. 1, but the present disclosure is not limited thereto.

In FIG. 3, FIG. 4A, FIG. 4B and FIG. 4C, each of the first teeth structures of the positioning portion 122 extends from one end of the positioning portion 122 to the other end of the positioning portion 122 along the direction parallel to the axial direction of the pivoting portion (that is, the axial direction of the pivoting axial member 101). Therefore, when the stopping member 130 is released from the positioning portion 122 and moved, and then the stopping member 130 can push the assisting structure 140 to totally separate from the positioning portion 122 for releasing the fixed preset angle between the driving head 120 and the handle 110, if the user would like to position the driving head 120 and the handle 110 at another angle, the stopping member 130 can be moved from the abutting member 142 of the assisting structure 140 towards the driving head 120 so as to engage the second teeth structures with the first teeth structures, and then the user can move the stopping member 130 towards the other end of the positioning portion 122 along the direction parallel to the axial direction of the pivoting portion. After the stopping member 130 is pushed by stepping structure 112, the adjusted preset angle between the driving head 120 and the handle 110 can be fixed. That is, since each of the first teeth structures is the structure from one end extending to the other end of the positioning portion 122, the problem or difficulty for the stopping structure 131 to align with the first teeth structures can be reduced, and it is favorable for increasing the convenience and smoothness during operation.

Further, as shown in FIG. 4B, a length L2 of the at least one second teeth structure is greater than one third of a length L1 of each of the first teeth structures and is smaller than a half of the length L1 of each of the first teeth structures. Therefore, it is favorable for solving the problem of alignment of the teeth structures during operation and enhancing the positioning strength between the stopping structure 131 and the positioning portion 122. Furthermore, in FIG. 3 and FIG. 4B, when a teeth thickness of each of the first teeth structures of the positioning portion 122 is x, and a thickness of the stepping structure 112 is TH, the following condition is satisfied: 0.5x≤TH≤0.95x. Therefore, it is favorable for further enhancing the positioning strength.

Moreover, due to the stopping structure 131 of the stopping member 130 should be disposed between the driving head 120 and the handle 110, the volume of the stopping member 130 needs to be maintained in a size which would not affect the relative rotation between the driving head 120 and the handle 110, it would lead that the volume of the stopping member 130 is too small to adjust the location. Hence, in FIG. 2, the stopping member 130 can further include two operating portions 132 connected to two ends of the stopping structure 131 and located on two sides of the handle 110, respectively. Further, each of two sides of each of the operating portions 132 can include a raised structure 1321. The operating portions 132 are crossly disposed on the handle 110 which can be exposed and are located outside of the handle 110, which is favorable for user to move the stopping structure 131. Further, the user can push the two operating portions 132 with the raised structures 1321 by the thumb and the forefinger simultaneously so as to increase the operating smoothness.

Therefore, the hand tool in the present disclosure can provide the following advantages. First, by the arrangement of the stepping structure, the preset angle between the driving head and the handle can be positioned by pushing the stopping member via a single structure, so that it is favorable for simplifying the elements in the hand tool and effectively reducing the weight and the manufacturing cost. Second, the first teeth structures are extended from one end to the other end of the positioning portion, so that the alignment problem or difficulty of the first teeth structures and the second teeth structure can be reduce and the operating smoothness can be enhanced. Third, the operating portions of the stopping member can increase the convenience during changing or adjusting the preset angle.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A hand tool, comprising:
a handle comprising:
a stepping structure located on one end of the handle;
a driving head pivotally connected to the end of the handle, and comprising:
a positioning portion located on one end of the driving head facing towards the handle; and
a stopping member disposed on the end of the handle, and comprising:
a stopping structure, wherein when the stopping member is pushed by the stepping structure towards the driving head, the stopping structure is positioned on the positioning portion so as to position the driving head and the handle with a preset angle.

2. The hand tool of claim 1, wherein the stepping structure is integrally formed with the handle.

3. The hand tool of claim 1, wherein the driving head further comprises:
a pivoting portion for pivotally connecting with the end of the handle;
wherein the positioning portion comprises a plurality of first teeth structures, which is disposed around an outer surface of the pivoting portion; the stopping structure comprises at least one second teeth structure for engaging with at least one of the first teeth structures.

4. The hand tool of claim 3, wherein each of the first teeth structures extends from one end of the positioning portion to the other end of the positioning portion along a direction parallel to an axial direction of the pivoting portion.

5. The hand tool of claim 3, wherein a length of the at least one second teeth structure is greater than one third of a length of each of the first teeth structures and is smaller than a half of the length of each of the first teeth structures.

6. The hand tool of claim 3, wherein a teeth thickness of each of the first teeth structures of the positioning portion is x, a thickness of the stepping structure is TH, and the following condition is satisfied:
0.5x≤TH≤0.95x.

7. The hand tool of claim 1, further comprising:
an assisting structure, wherein the handle has an concave hole located on the end of the handle and being adjacent to the stepping structure, and the assisting structure is protrudably disposed in the concave hole.

8. The hand tool of claim 7, wherein the assisting structure comprises:
an elastic member, wherein one end of the elastic member is positioned in the concave hole; and
an abutting member connected to the other end of the elastic member.

9. The hand tool of claim 7, wherein the stopping member further comprises:
two operating portions connected to two ends of the stopping structure and located on two sides of the handle, respectively.

10. The hand tool of claim 9, wherein each of two sides of each of the operating portions comprises a raised structure.

11. The hand tool of claim 7, wherein when the stopping member is pushed by the stepping structure towards the driving head, the stopping member is not physically contacted with the assisting structure.

12. The hand tool of claim 7, wherein the stepping structure comprises a tilting surface located on an edge of the stepping structure facing towards the assisting structure.
